(19) United States
(12) Patent Application Publication
(10) Pub. No.: US 2010/0042461 A1
(43) Pub. Date: Feb. 18, 2010

(54) GROUPING SERVICE ORDERS IN AN ELECTRONIC SERVICES MARKETPLACE

(75) Inventors: Sarah E. Carpenter, Hoffman Estates, IL (US); George A. Coll, Lake Barrington, IL (US); Rhett A. Butler, Buffalo Grove, IL (US)

Correspondence Address: GREENBERG TRAURIG, LLP, 77 WEST WACKER DRIVE, SUITE 3100, CHICAGO, IL, 60601-1732, US

(73) Assignee: Sears Brands, LLC, Hoffman Estates, IL (US)

(21) Appl. No.: 12/261,441

(22) Filed: Oct. 30, 2008

Related U.S. Application Data
(60) Provisional application No. 61/089,366, filed on Aug. 15, 2008.

(51) Int. Cl. G06Q 30/00; G06Q 10/00

(52) U.S. Cl. 705/9; 705/26; 705/14.58

(57) ABSTRACT

Described herein is technology for, among other things, grouping service orders in an electronic services marketplace. The technology involves receiving first and second service orders, comparing the first and second service orders, determining whether a relationship exists between certain criteria of the first and second service orders, and routing the first and second service orders together to a service provider that is to perform the services associated with the first and second service orders, when there is a relationship between the certain criteria of the first and second service orders.

### CLAIM OF PRIORITY UNDER 35 U.S.C. §119

The present Application for Patent claims priority to Provisional Application No. 61/089,366 entitled “Grouping Service Orders in an Electronic Services Marketplace” filed Aug. 15, 2008, and hereby expressly incorporated by reference herein.

### BACKGROUND

1. Field

Embodiments of the present invention generally relate to the field of electronic services marketplaces.

2. Background

Recently, online service marketplaces have become increasingly more common. Typically, these websites serve as bulletin board systems to facilitate the initial contacts between service buyers and service providers. Other online service marketplace sites provide more robust platforms that manage service requests from start to finish, and some even facilitate payment for the services.

Even the most robust conventional online service marketplaces are not without their inefficiencies, however. In particular, conventional online service marketplaces do not have the ability to recognize relationships between separate service requests that may lend themselves to certain efficiencies. For example, if John Doe submits a request for dishwasher installation one day, and then submits a request for microwave installation the next, conventional online services marketplaces will treat these as separate requests, ignoring the fact that the same buyer has requested the same general type of service (i.e., home appliance installation). Thus, if service provider ABC Installers would like to perform both services, ABC Installers must respond to both service requests. In such a scenario, it is possible that another service provider may respond to one of the service requests before ABC Installers does, and therefore “win” the service order.

This type of scenario is disadvantageous to everyone involved. First, ABC Installers loses out on the efficiency of performing two services for the same customer at the same location. Second, it is inconvenient for John Doe to have to deal with multiple service providers, when both requested services could potentially have been performed by the same service provider. Moreover, since service providers typically build a “trip charge” into their cost for on-site services, John Doe is forced to pay two such trip charges, since he is dealing with two separate service providers.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Described herein is technology for, among other things, grouping service orders in an electronic services marketplace. The technology involves receiving first and second service orders, comparing the first and second service orders, determining whether a relationship exists between certain criteria of the first and second service orders, and routing the first and second service orders together to a service provider that is to perform the services associated with the first and second service orders, when there is a relationship between the certain criteria of the first and second service orders.

Thus, service buyers and service providers alike receive the added value of grouped services. The buyer only has to deal with one service provider. This allows the buyer to begin building a relationship with a single service provider and saves the buyer the hassle of trying to coordinate scheduling with multiple service providers. The service provider benefits from the fact that by accepting grouped service orders, the service provider is spending more time rendering services and less time travelling from service location to service location.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 illustrates an exemplary operating environment for implementing embodiments;

FIG. 2 illustrates a services marketplace system, in accordance with various embodiments of the present invention;

FIGS. 3A-B illustrate a flowchart of a process for grouping orders, in accordance with various embodiments of the present invention;

FIG. 4 illustrates forming a grouped service order from two ungrouped service orders, in accordance with various embodiments of the present invention;

FIG. 5 illustrates forming a grouped service order from a grouped service order and an ungrouped service order, in accordance with various embodiments of the present invention;

FIG. 6 illustrates forming two grouped service orders from a grouped service order and an ungrouped service order, in accordance with various embodiments of the present invention; and

FIG. 7 illustrated forming two grouped service orders from two grouped service orders and an ungrouped service order, in accordance with various embodiments of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the claims. Furthermore, in the detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Some portions of the detailed descriptions that follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels and are to be interpreted further in view of terms commonly used in the art. Unless specifically stated otherwise as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

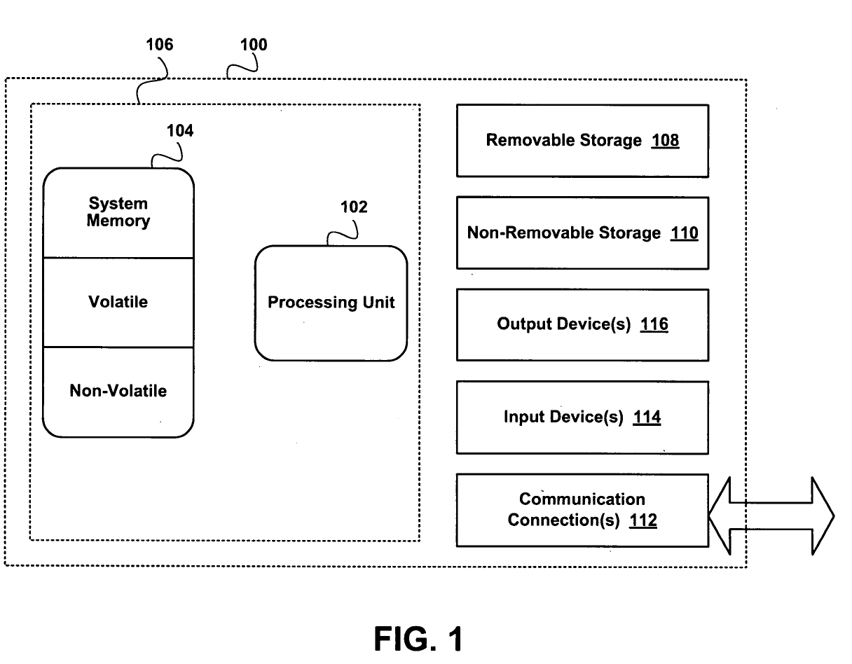

With reference to FIG. 1, an exemplary system for implementing embodiments includes a general purpose computing system environment, such as computing system environment 100. In its most basic configuration, computing system environment 100 typically includes at least one processing unit 102 and memory 104. Depending on the exact configuration and type of computing system environment, memory 104 may be volatile (such as RAM), non-volatile (such as ROM, flash memory, etc.) or some combination of the two. This most basic configuration is illustrated in FIG. 1 by dashed line 106. Additionally, computing system environment 100 may also have additional features/functionality. For example, computing system environment 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 100. Any such computer storage media may be part of computing system environment 100.

Computing system environment 100 may also contain communications connection(s) 112 that allow it to communicate with other devices. Communications connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media. Computing system environment 100 may also have input device(s) 114 such as a keyboard, mouse, pen, voice input device, touch input device, etc. Output device(s) 116 such as a display, speakers, printer, etc. may also be included. All these devices are well known in the art and need not be discussed at length here.

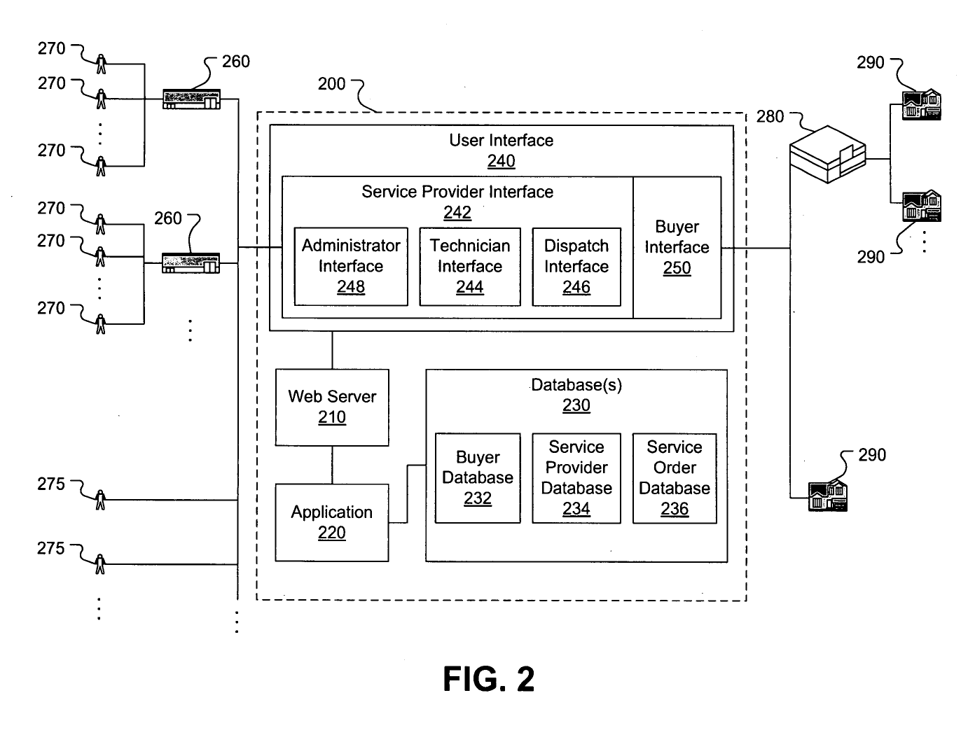

FIG. 2 illustrates a services marketplace system 200, in accordance with various embodiments of the present invention. System 200 is well-suited for operation on the Internet. However, system 200 may also be implemented on various other communication networks and/or mediums.

Generally speaking, system 200 is operable to facilitate the routing of service requests from various different types of buyers to various different types of service providers. The buyer/service requester may be a consumer 290. The buyer/service requester may also be an enterprise buyer 280, such as a home-improvement store or other department store, which orders services on behalf of one or more consumers 290. Based on the type and scope of the requested services, a service order is routed to an appropriate service provider. The service provider may be a service provider company 260 having a team of multiple technicians 270, or the service provider may be a sole proprietor 275. The requests for services can involve a wide range of primary service categories, including but not limited to home electronics, home appliances, HVAC, and garage and shed. It therefore follows that the service requests can also involve a wide range of services, including but not limited to installation of household applications, such as a garage door opener, a water heater, a furnace, an air conditioner, a dishwasher, a garbage disposal, a water softener, and the like; television installation; home theater installation; computer set-up; home computer network set-up; installation of a shed or fence; and installation of cabinetry—just to name a few.

System 200 includes a web server 210, which is operable to manage communications between various service providers 260, 270, 275 and various service buyers 280, 290. The web server 210 may communicate with various service providers 260, 270, 275 and various service buyers 280, 290 via a user interface 240. The user interface 240 may include a service provider interface 242 and a buyer interface 250. The service provider interface 242 may further include a separate administrator interface 248, technician interface 244, and dispatch interface 246.

Web server 210 is in communication with an application 220 that is operable to process the communications between the service providers 260, 270, 275 and the buyers 280, 290. The application 220 may operate on the same physical machine as the web server 210, or it may operate on a separate machine. Moreover, the processing of application 220 may also be distributed across several machines. The operations of application 220 are discussed at greater length below.

The application 220 is communicatively coupled with one or more databases 230. The databases 230 store profiles for each of the buyers 280, 290 and service providers 260, 270, 275, as well as data relating to service orders in the system 200. Accordingly, databases 230 may include a separate buyer database 232, service provider database 234, and service order database 236, which may or may not be physically separate from each other.

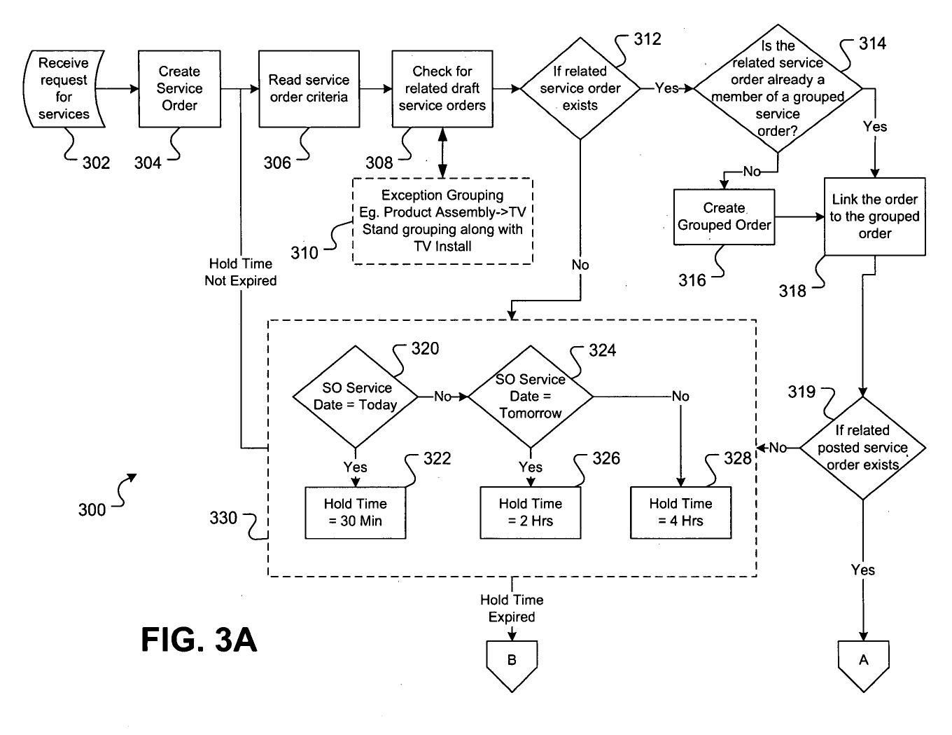

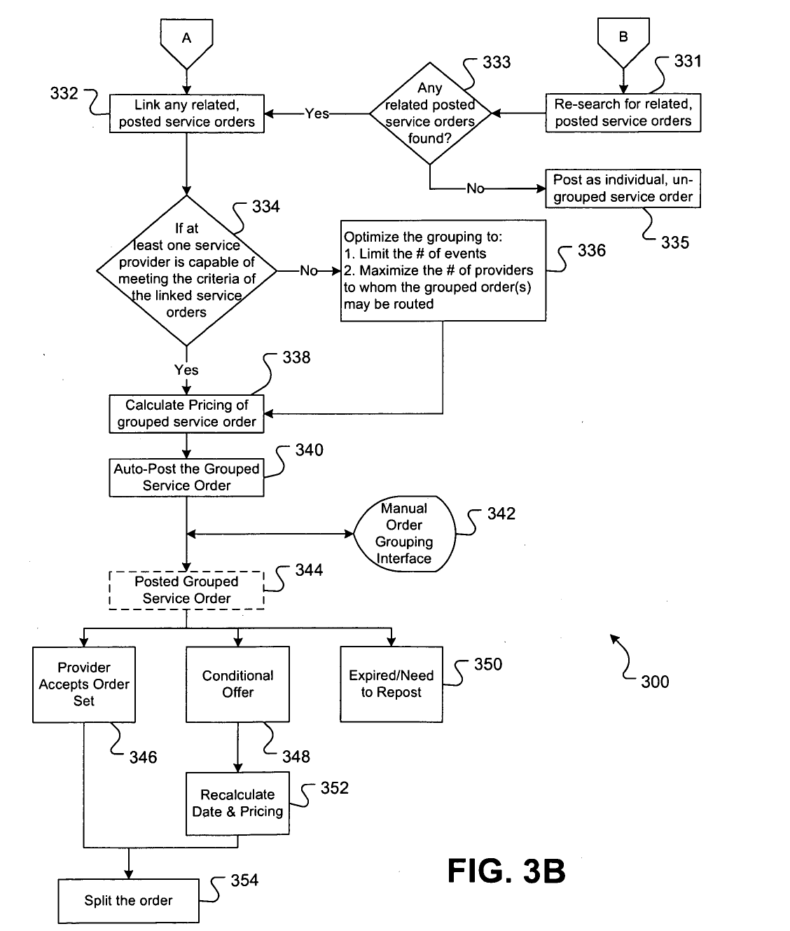

The following discussion sets forth in detail the operation of present technology for a services marketplace system. With reference to FIGS. 3A-B, flowchart 300 illustrates example steps used by various embodiments of the present technology for grouping service orders. Flowchart 300 includes processes that, in various embodiments, are carried out by a processor under the control of computer-readable and computer-executable instructions. The computer-readable and computer-executable instructions may reside, for example, in data storage features such as storage devices 108, 110 of FIG. 1. Although specific operations are disclosed in flowchart 300, such operations are examples. That is, embodiments are well suited to performing various other operations or variations of the operations recited in flowchart 300. It is appreciated that the operations in flowchart 300 may be performed in an order different than presented, and that not all of the operations in flowchart 300 may be performed. Where helpful for the purposes of illustration, and not for limitation, FIGS. 3A-B will be described with reference to FIGS. 2 and 4-7, which illustrate hypothetical situations in which embodiments may be implemented.

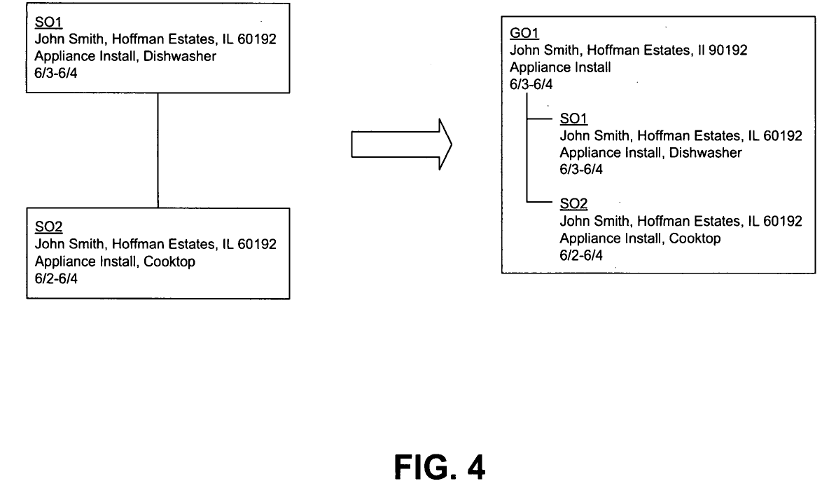

In one embodiment, flowchart 300 begins at block 302, where a request for services is received, by way of example, through buyer interface 250. The request for services may include various types of information, such as the buyer's contact information, the service location, a category of the requested services, a description of the requested services, a service date or date range, and a service price, but is not limited as such. At block 304, a service order is created based on the buyer's request for services. For example, as shown in FIG. 4, a service order (e.g., SO1) may be created for the buyer John Smith, who lives in Hoffman Estates, Illinois, and would like to have a dishwasher installed some time between June 3 and June 4. As shown, John Smith has also placed a second service order for a cooktop to be installed at the same location some time between June 2 and June 4.

At block 306, the service order's criteria (service category, service location, service date(s), etc.) is read, and then a search is performed for any related, non-posted service orders (block 308). The determination of whether two service orders are related is based on an application of one or more business rules to the criteria of the respective service orders. For example, in one embodiment, two service orders may be considered related if they involve the same category of service, for the same service location, and have common service dates. It should be appreciated, however, that more (or less) complex business rules may also be used. For example, it may be beneficial to link two service orders for the same day and the same category of service, but for different service locations, so long as the service locations are within a common geographic region, are less than a predetermined distance from each other, etc. Moreover, the business rules may also account for certain exceptions. As illustrated by block 310, even though television stand assembly and television installation involve separate service categories, they may nonetheless be considered related due to the fact that they both involve a television. In the example of FIG. 4, it is determined that SO1 and SO2 are related because they involve the same service location (e.g., Hoffman Estates), the same category of service (e.g., appliance installation), and common service dates (e.g., June 3-4).

If one or more related service orders are found (block 312), a determination is made as to whether the related service order(s) is/are already a member(s) of a grouped service order (bock 314). If yes, then the new service order is simply linked to the grouped service order (block 318) and becomes a component service order thereof. If not, the grouped service order is created (block 316), and then the service orders are linked to the new grouped service order (block 318). In the example of FIG. 4, since neither SO1 nor SO2 were members of a grouped service order, a new grouped service order (GO1) is created for appliance installation, in Hoffman Estates, between June 3 and June 4 (e.g., the overlapping service dates for SO1 and SO2).

It is possible that one or more service orders that have already been posted (which may or may not already be members of one or more existing grouped service orders) may also be considered related to a new service order. Thus, at block 319, a determination is made as to whether there are any related, posted orders. In one embodiment, if no related, posted orders are found, the new service order (and its related, un-posted service orders, if any) is held for a period of time before it is posted to service providers, to allow time for other potentially related service orders to be submitted and grouped with the new service order. The length of time for which the new service order is held before it is posted may vary. In one embodiment, the length of time a service order stays in the queue depends on the urgency of the service order (i.e., how soon the service order is scheduled to be completed). Block 330 of flowchart 300 shows one example of how the length of the hold time is determined. As shown, if the new service order is for a same-day service (block 320), it is only held for thirty minutes (block 322). If the new service order is for a next-day service (block 324), it is held for two hours (block 326). Otherwise, the new service order is held for four hours (block 328) before it is posted to the service providers. Prior to posting the new service order, the already-posted service orders are searched again for related service orders (block 331). If no related, posted service orders are found (block 333), the service order is posted to the service providers as an individual, ungrouped service order (block 335).

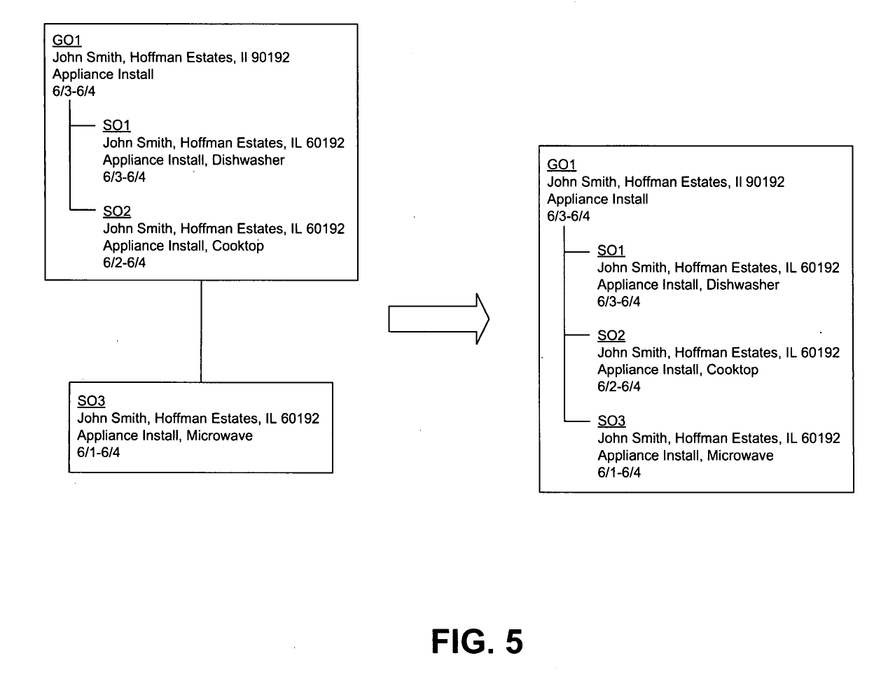

In either the case of block 319 or block 333, if one or more related, posted orders are found, flowchart 300 proceeds to block 332, where the new service order is linked to the related, posted service orders. As shown in FIG. 5, John Smith has submitted a third service order (SO3) for microwave installation, in Hoffman Estates, for some time between June 1 and June 4. Service orders SO1 and SO2 of group order GO1 are both related SO3 because they involve the same service location (e.g., Hoffman Estates), the same category of service (e.g., appliance installation), and common service dates (e.g., June 3-4). Thus, in the illustrated embodiment, SO3 is linked with SO1, SO2, and GO1.

Next, at block 334, a determination is made as to whether at least one service provider meets the criteria of the grouped service order—that is, whether there is any service provider registered in 234 that is capable of performing all the component service orders of the grouped service order. For example, SO1 and SO2 may be considered related, but, for one reason or another, no single service provider may be qualified to perform the services of both SO1 and SO2. If at least one service provider does meets the criteria of the grouped service order, a price is calculated for the grouped service order (block 338), and the group service order is posted (block 340). If not, the grouped service order is broken up into multiple grouped service orders and/or individual, ungrouped service orders. In one embodiment, this re-allocation of the component service orders is optimized first to minimize the number of events. As used herein, the term “event” shall refer to any posted, grouped service orders or any posted, ungrouped service orders. The re-allocation of service orders may then be optimized so as to maximize the pool of service providers to which the events may be provided.

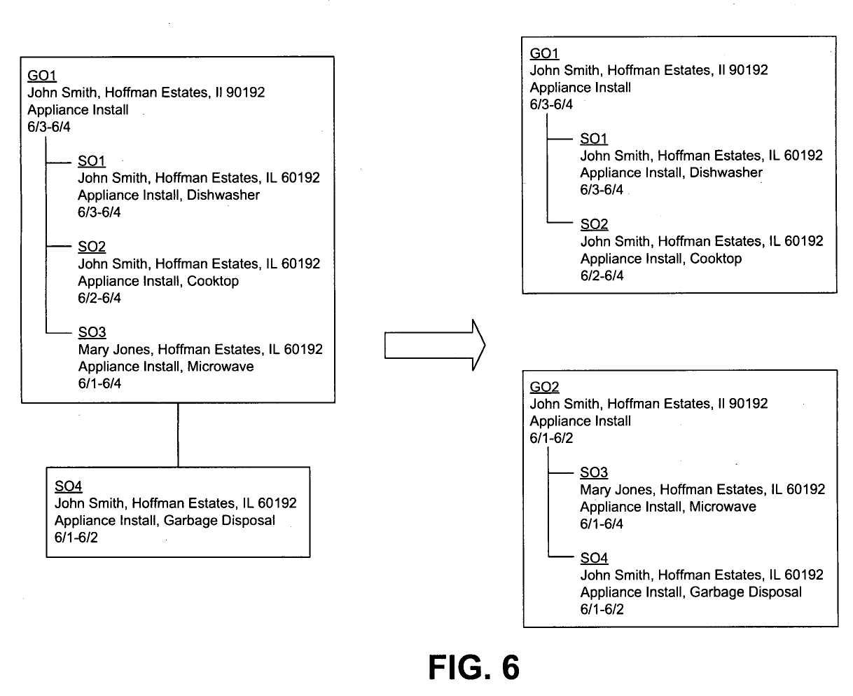

For example, as shown in FIG. 6, John Smith has submitted a fourth service order (SO4) for garbage disposal installation, in Hoffman Estates, for some time between June 1 and June 2. With reference to the already-posted group order GO1, it should be appreciated that SO4 is considered a related service order with respect to SO2 and SO3, but not with respect to SO1. Specifically, the service dates of SO4 do not overlap with those of SO1, but they do overlap with those of SO2 and SO3—namely, June 2. Thus, a decision must be made as to whether to rearrange the order grouping. As discussed above, rearrangement of the order grouping is optimized so as to minimize the total number of events. In the scenario presented in FIG. 6, all four service orders cannot be grouped together in a single grouped service order; however it will be appreciated that four possible arrangements can be achieved that result in only two events: 1) SO1-SO2-SO3 and SO4; 2) SO1-SO2 and SO3-SO4; 3) SO1-SO3 and SO2-SO4; and 4) SO1 and SO2-SO3-SO4. The selection of the optimum arrangement is then based upon which arrangement results in the largest pool of service providers to which the events may be provided. Table 1 shows a hypothetical example of the number of service providers that each possible grouping of service orders may be provided. Since, according to Table 1, Arrangement #2 may be provided to a greater total number of service providers (24) than each of Arrangement #1 (21), Arrangement #3 (16), or Arrangement #4 (22), Arrangement #2 therefore represents the optimum arrangement of the four service orders, according to one embodiment. Accordingly, SO3 is removed from GO1, and a new grouped service order (GO2) is created for appliance installation, in Hoffman Estates, between June 1 and June 2.

TABLE 1

| | | Qualifying | Arrangement |
|---|---|---|---|
| | Grouping | Providers | Total |
| Arrangement | SO1-SO2-SO3 | 6 | 21 |
| #1 | SO4 | 15 | |
| Arrangement | SO1-SO2 | 14 | 24 |
| #2 | SO3-SO4 | 10 | |
| Arrangement | SO1-SO3 | 12 | 16 |
| #3 | SO2-SO4 | 4 | |
| Arrangement | SO1 | 20 | 22 |
| #4 | SO2-SO3-SO4 | 2 | |

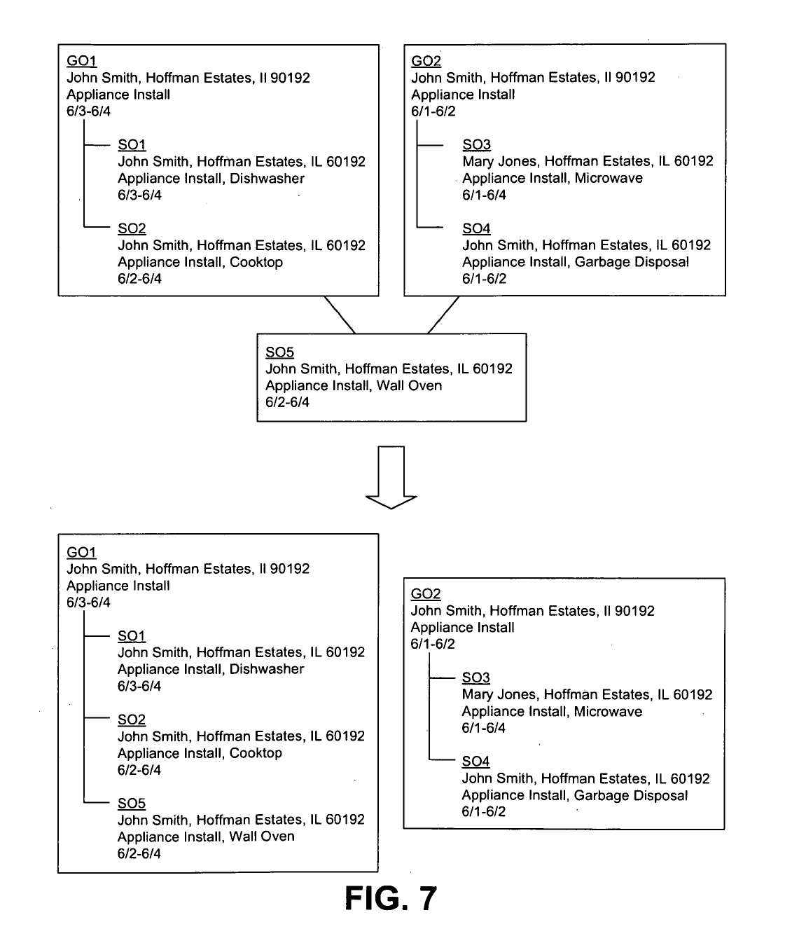

Continuing with the present hypothetical, John Smith may submit yet another, fifth service order (SO5), as shown in FIG. 7—this time for a wall oven installation, in Hoffman Estates, for some time between June 2 and June 4. It will again be appreciated that SO5 will be considered a related service order with each of SO1, SO2, SO3 and SO4, but since SO1 and SO4 are not related, a minimum of two events is required. Table 2 illustrates the eight possible permutations of these five service orders into two events, together with hypothetical numbers of service providers that each possible grouping of service orders may be provided. Since, according to Table 2, Arrangement #3 may be provided to a greater total number of service providers (22) than each of the seven other arrangements, Arrangement #3 therefore represents the optimum arrangement of the five service orders, according to the present embodiment. Accordingly, SO5 is grouped into GO1 together with SO1 and SO2.

TABLE 2

| | | Qualifying | Arrangement |
|---|---|---|---|
| | Grouping | Providers | Total |
| Arrangement | SO1-SO2-SO3-SO5 | 5 | 20 |
| #1 | SO4 | 15 | |
| Arrangement | SO1-SO2-SO3 | 6 | 17 |
| #2 | SO4-SO5 | 11 | |
| Arrangement | SO1-SO2-SO5 | 12 | 22 |
| #3 | SO3-SO4 | 10 | |
| Arrangement | SO1-SO3-SO5 | 9 | 13 |
| #4 | SO2-SO4 | 4 | |
| Arrangement | SO1-SO2 | 14 | 19 |
| #5 | SO3-SO4-SO5 | 5 | |
| Arrangement | SO1-SO3 | 12 | 14 |
| #6 | SO2-SO4-SO5 | 2 | |
| Arrangement | SO1-SO5 | 14 | 16 |
| #7 | SO2-SO3-SO4 | 2 | |
| Arrangement | SO1 | 20 | 20 |
| #8 | SO2-SO3-SO4-SO5 | 0 | |

Once the optimization is complete, pricing is calculated for any resulting grouped service orders (block 338), and the grouped and ungrouped service orders are then posted (block 340). In various embodiments, due to the grouping of two or more service orders together, a grouped order discount may be applied to the pricing of grouped service orders. In one embodiment, the discount may be determined according to the following function:

$$Discount = \frac{[ count\_of \_service \_orders \_in \_group ] - 1}{[ count\_of \_service \_orders \_in \_group ]} \times trip\_charge \_fee$$

Thus, the greater the number of service orders in a group, the greater the discount.

In one embodiment, an order grouping user interface may be provided (block 342) for enabling a user, such as a service provider or a system administrator, to manually group certain service orders together, and also to manually ungroup one or more individual service orders from a grouped service order. For example, a particular service provider may be skilled in both computers and audio/video. In this case, the service provider could use the manual grouping interface to group together separate service orders which ordinarily may not be grouped together by default, such as a service order for a home computer network setup and a service order for home theater setup.

In one embodiment, once a grouped service order has been posted (block 344), the grouped service order may have several possible fates. First, the grouped service order may simply go unaccepted by any service providers and subsequently expire (block 350). The grouped service order may also be accepted (block 348). A service provider may also respond to the grouped service order with a conditional offer (i.e., counter-offer), in which the service provider agrees to accept the service order under slightly different terms, such as for a different price or on a different date than proposed (block 348).

Once a service provider has accepted the grouped service order or the buyer has accepted the service provider's conditional offer, the grouped service order may then be “split apart” or unbundled into its component service orders (block 354). Unbundling the group after acceptance preserves the one-to-one relationship of the service orders, which, for some buyers and service providers, is important in the context of order tracking. Thus, it is subsequently possible for a service provider to “close out” one or more component service orders of a group, while leaving one or more other service orders open. This may be helpful in cases where the service provider was able to complete some, but not all, of the requested services, because additional parts needed to be ordered, for example.

Thus, service buyers and service providers alike receive the added value of grouped services. The buyer only has to deal with one service provider. This allows the buyer to begin building a relationship with a single service provider and saves the buyer the hassle of trying to coordinate scheduling with multiple service providers. The service provider benefits from the fact that by accepting grouped service orders, the service provider is spending more time rendering services and less time travelling from service location to service location.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of grouping service orders, comprising:
receiving a first service order and a second service order;
comparing the first service order with the second service order;
determining whether a relationship exists between certain criteria of the first and second service orders; and
routing the first and second service orders together to a service provider when there is a relationship between the certain criteria of the first and second service orders, wherein the service provider is to perform the services associated with the first and second service orders.

2. The method as recited in claim 1, wherein the first service order and the second service order are received at different times.

3. The method as recited in claim 1, further comprising:
creating a grouped service order comprising the first and second service orders, when there is a relationship between the certain criteria of the first and second service orders, and
wherein routing the first and second service orders together to the service provider comprises routing the grouped service order to the service provider.

4. The method as recited in claim 1, wherein the criteria includes one or more items selected from the group consisting of a service date, a service date range, a service location, a geographic region corresponding to the service order, and a service category.

5. The method as recited in claim 1, wherein the first service order includes a first price and the second service order includes a second price, and wherein the method further comprises:
determining a discounted grouped service order price based on the first price, the second price, and a discount function.

6. The method as recited in claim 1, wherein determining whether a relationship exists between certain criteria of the first and second service orders comprises:
determining whether the first and second service orders involve a same service category;
determining whether the first and second service orders involve respective service locations that are geographically related; and
determining whether the first and second service orders involve any overlapping service dates,
wherein the relationship exists between the first and second service orders when the first and second service orders involve the same service category, involve geographically related service locations, and involve overlapping service dates.

7. The method as recited in claim 6, wherein determining whether the first and second service orders involve respective service locations that are geographically related comprises:
determining whether the respective service locations of the first and second service orders are the same.

8. The method as recited in claim 6, wherein determining whether the first and second service orders involve respective service locations that are geographically related comprises:
determining whether the respective service locations of the first and second service orders are less than a maximum distance from each other.

9. The method as recited in claim 6, wherein determining whether the first and second service orders involve respective service locations that are geographically related comprises:
determining whether the respective service locations of the first and second service orders are within a within a same zip code.

10. The method as recited in claim 6, wherein determining whether the first and second service orders involve respective service locations that are geographically related comprises:
determining whether the respective service locations of the first and second service orders are within a same city.

11. The method as recited in claim 1 further comprising:
determining whether the first and second service orders satisfy an exception, when it is determined that a relationship does not exist between the certain criteria of the first and second service orders; and
routing the first and second service orders together to the service provider when the first and second service orders satisfy the exception, wherein the service provider is to perform the services associated with the first and second service orders.

12. The method as recited in claim 1, further comprising:
routing the first service order to the service provider as an individual, un-grouped service order, for acceptance, when it is determined that a relationship does not exist between the first and second service orders.

13. The method as recited in claim 12, further comprising:
waiting a length of time before routing the first service order to the service provider as the individual, un-grouped service order, for acceptance, when it is determined that the relationship does not exist between the first and second service orders.

14. The method as recited in claim 13, wherein the length of time varies depending on a service date of the first service order.

15. A method of grouping service orders for subsequent provision to a plurality of service providers, comprising:
receiving a new service order;
comparing the new service order with other pending service orders;
determining whether a relationship exists between the new service order and one or more of the other pending service orders;
linking the new service order with the related pending service orders;
creating a new grouped service order including the new service order and one or more of the related pending service orders; and
providing the new grouped service order to one or more of the service providers for acceptance.

16. The method as recited in claim 15, wherein the pending service orders comprise one or more existing grouped service orders and one or more ungrouped individual service orders, wherein the one or more existing grouped service orders, the one or more individual ungrouped service orders, and the new grouped service order are each an event, and wherein creating the new grouped service order comprises grouping the new service order with the one or more of the related pending service orders so as to minimize a total number of events.

17. The method as recited in claim 16, wherein creating the new grouped service order further comprises creating the new grouped service order so as to maximize the number of service providers that satisfy service provider criteria of the events.

18. The method as recited in claim 15, further comprising:
providing a user interface for enabling a user to ungroup one or more component service orders from an existing grouped service order.

19. The method as recited in claim 15, further comprising:
providing a user interface for enabling a user to manually group two or more individual ungrouped service orders with each other.

20. The method as recited in claim 15, further comprising:
providing a user interface for enabling a user to manually group one or more individual ungrouped service orders with an existing grouped service order.

21. The method as recited in claim 15, further comprising:
ungrouping the new grouped service order into its component service orders after the new grouped service order has been accepted by a particular service provider; and
managing life cycles of the component service orders independently from one another.
